(19) United States
(12) Patent Application Publication
(10) Pub. No.: US 2009/0036175 A1
(43) Pub. Date: Feb. 5, 2009

(54) Mobile Telephone Case

(75) Inventors: Kyle Brandenburg, Philadelphia, PA (US); Edward Martin, Hollywood, FL (US)

Correspondence Address: LERNER GREENBERG STEMER LLP, P O BOX 2480, HOLLYWOOD, FL, 33022-2480, US

(73) Assignee: MARWARE, INC., Hollywood, FL (US)

(21) Appl. No.: 11/830,359

(22) Filed: Jul. 30, 2007

(51) Int. Cl. H04M 1/00

(52) U.S. Cl. 455/575.1

(57) ABSTRACT

A mobile telephone case includes a shell and an insert disposed in the shell. The insert has a reel for receiving a cord to be wound thereon. The insert also has clips for holding a mobile telephone.

### BACKGROUND OF THE INVENTION

1. Field of the Invention

The invention relates to a case for a mobile telephone, such as the iPhone produced by Apple. The iPhone combines a mobile telephone, digital mulimedia player and camera and has a multi-touch screen with a virtual keyboard and buttons as well as various ports, such as for charging, USB connection and ear bud connection.

2. Description of the Related Art

Many cases for digital media players and mobile telephones are available. Different cases cover or grasp the digital media player or mobile telephone in different ways and have various devices for attaching the case, such as belt clips. Some cases for the iPod and other digital media players have devices for accommodating ear bud cords at the back of the case, such as the Backwinder produced by Marware, Inc. and described in co-pending U.S. application Ser. No. 11/331,985 and allowed U.S. Design application Ser. No. 29/251,854, and the Jam Jacket produced by DLO. Those cases are formed of a soft silicone rubber and therefore could not support a device for attaching the case. Some silicone rubber cases are intended to be easily pulled over the digital media player without opening the case. A case produced by Elecom has a winder projection at the side for winding an ear bud cord. Macally manufactures an Icesuit case having a rear winder storage location with a projection for an ear bud cord. The Sidewinder produced by Marware, Inc. and described in co-pending U.S. application Ser. No. 11/331,986 and allowed U.S. Design application Ser. No. 29/251,840 has a device for accommodating an ear bud cord.

None of the prior art cases provide a device for attaching the case, a device for accommodating ear bud cords at the back of the case and the ability to pull the case over the digital media player or mobile telephone without opening the case. Furthermore, those prior art cases are not intended to accommodate the iPhone.

### SUMMARY OF THE INVENTION

It is accordingly an object of the invention to provide a mobile telephone case, which overcomes the hereinafore-mentioned disadvantages of the heretofore-known devices of this general type, which has a device for attaching the case, a device for accommodating ear bud cords at the back of the case and the ability to pull the case over the digital media player or mobile telephone without opening the case. Furthermore, the case should accommodate the iPhone.

With the foregoing and other objects in view there is provided, in accordance with the invention, a mobile telephone case, comprising a shell and an insert disposed in the shell. The insert has a reel for receiving a cord to be wound thereon as well as clips for holding a mobile telephone. The shell may be formed of a pliant material to be pulled over the mobile telephone without opening the case, and the insert may be formed of a rigid material for supporting a device for attaching the case. Therefore, the case provides the ability to support a device for attaching the case, a device for accommodating ear bud cords at the back of the case, the ability to pull the case over the digital media player or mobile telephone without opening the case, and it is intended to accommodate the iPhone. The clips are disposed within the shell for holding the mobile telephone within the shell.

In accordance with another feature of the invention, the shell has front and rear surfaces. The front surface has a cutout for accessing a screen of the mobile telephone, and the rear surface has at least one slot through which the reel extends. The mobile telephone can be inserted through the cutout into the shell and the insert is stiff enough to support the reel. The reel may also be formed as reel segments extending through multiple slots in the rear surface of shell.

In accordance with a further feature of the invention, the insert has a mounting extending through an opening in a rear surface of the shell for receiving a belt clip. The insert is stiff enough to support the mounting and belt clip. The opening may be a central opening, the shell has projections with slits formed therein for receiving the cord, the projections are disposed laterally of the central opening and the slots are disposed above and below the central opening. Thus, the cord is wound about the reel segments and the projections outside the central mounting, to prevent interference therebetween.

In accordance with an added feature of the invention, the clips and the reel project from opposite surfaces of the insert. Therefore, the grasping of the mobile telephone by the clips also does not interfere with the winding of the cord and the central mounting. The clips may have projections thereon engaged in openings in the shell to keep the shell and the insert fixed in place relative to each other.

In accordance with an additional feature of the invention, the shell has a front surface partially covering the mobile telephone, so as to cushion the mobile telephone against damage and protect it from soiling.

In accordance with a concomitant feature of the invention, the shell has cutouts and/or embossed areas for accessing at least one of controls, ports and a camera lens of the mobile telephone. This permits the maximum possible coverage of the surface of the mobile telephone.

Other features which are considered as characteristic for the invention are set forth in the appended claims.

Although the invention is illustrated and described herein as embodied in a mobile telephone case, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, front-elevational view of an assembled mobile telephone case according to the invention;

FIG. 2 is a right side-elevational view of the assembled mobile telephone case of FIG. 1;

FIG. 3 is a top-plan view of the assembled mobile telephone case of FIG. 1;

FIG. 4 is a left side-elevational view of the assembled mobile telephone case of FIG. 1;

FIG. 5 is a bottom-plan view of the assembled mobile telephone case of FIG. 1;

FIG. 6 is a rear-elevational view of the assembled mobile telephone case of FIG. 1;

FIG. 7 is another rear-elevational view of the assembled mobile telephone case of FIG. 1 with ear buds and a cord wrapped in place;

FIG. 8 is a rear-perspective view of the assembled mobile telephone case of FIG. 1;

FIG. 9 is a front-perspective view of the assembled mobile telephone case of FIG. 1;

FIG. 10 is a front-elevational view of a disassembled outer shell of the mobile telephone case according to the invention;

FIG. 11 is a right side-elevational view of the disassembled outer shell of the mobile telephone case of FIG. 10;

FIG. 12 is a top-plan view of the disassembled outer shell of the mobile telephone case of FIG. 10;

FIG. 13 is a left side-elevational view of the disassembled outer shell of the mobile telephone case of FIG. 10;

FIG. 14 is a bottom-plan view of the disassembled outer shell of the mobile telephone case of FIG. 10;

FIG. 15 is a rear-elevational view of the disassembled outer shell of the mobile telephone case according to the invention;

FIG. 16 is a rear-elevational view of a disassembled insert of the mobile telephone case according to the invention;

FIG. 17 is a top-plan view of the disassembled insert of the mobile telephone case of FIG. 16;

FIG. 18 is a side-elevational view of the disassembled insert of the mobile telephone case of FIG. 16;

FIG. 19 is a front-elevational view of the disassembled insert of the mobile telephone case of FIG. 16;

FIG. 20 is a bottom-plan view of the disassembled insert of the mobile telephone case of FIG. 16; and

FIG. 21 is an exploded, perspective view of the insert and shell of the mobile telephone case according to the invention, prior to assembly.

### DESCRIPTION OF THE PREFERRED EMBODIMENTS

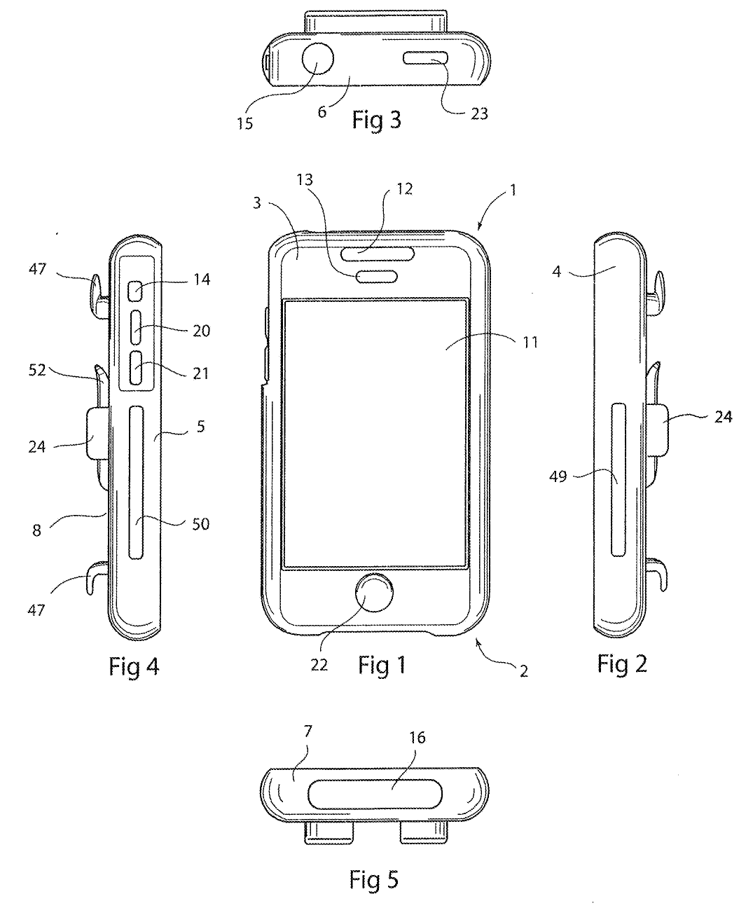

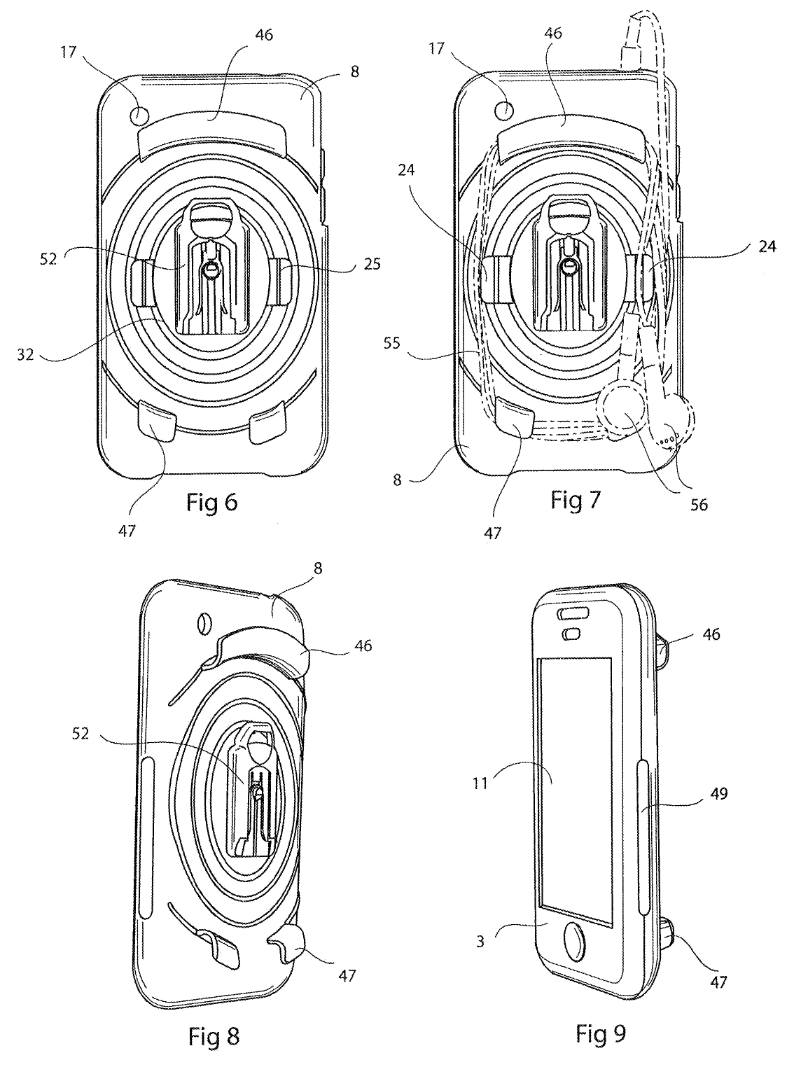

Referring now to the figures of the drawings in detail and first, particularly, to FIGS. 1-9 thereof, there is seen an assembled case 1 according to the invention for receiving a mobile telephone, especially an Apple iPhone. The case 1 has a shell 2 and an insert 40, the assembly of which will be discussed in greater detail below. The shell 2 is formed of a relatively pliant and resilient material, such as silicone rubber or NEOPRENE®, so that it can be pulled over the mobile telephone without opening the case. The insert 40, which will also be described in detail below, is formed of a relatively hard and stiff plastic to support a device for attaching the case.

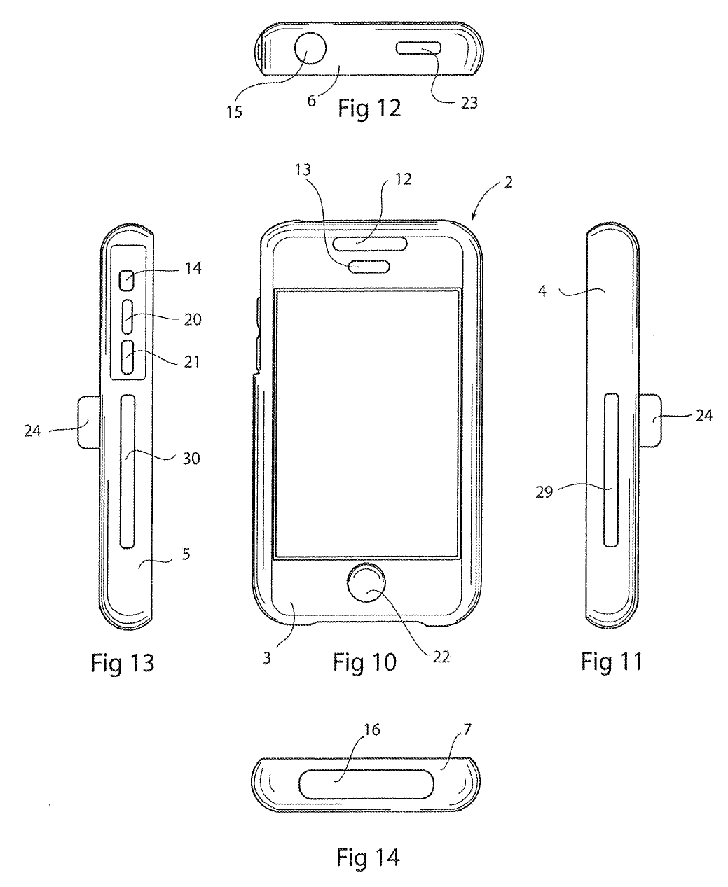

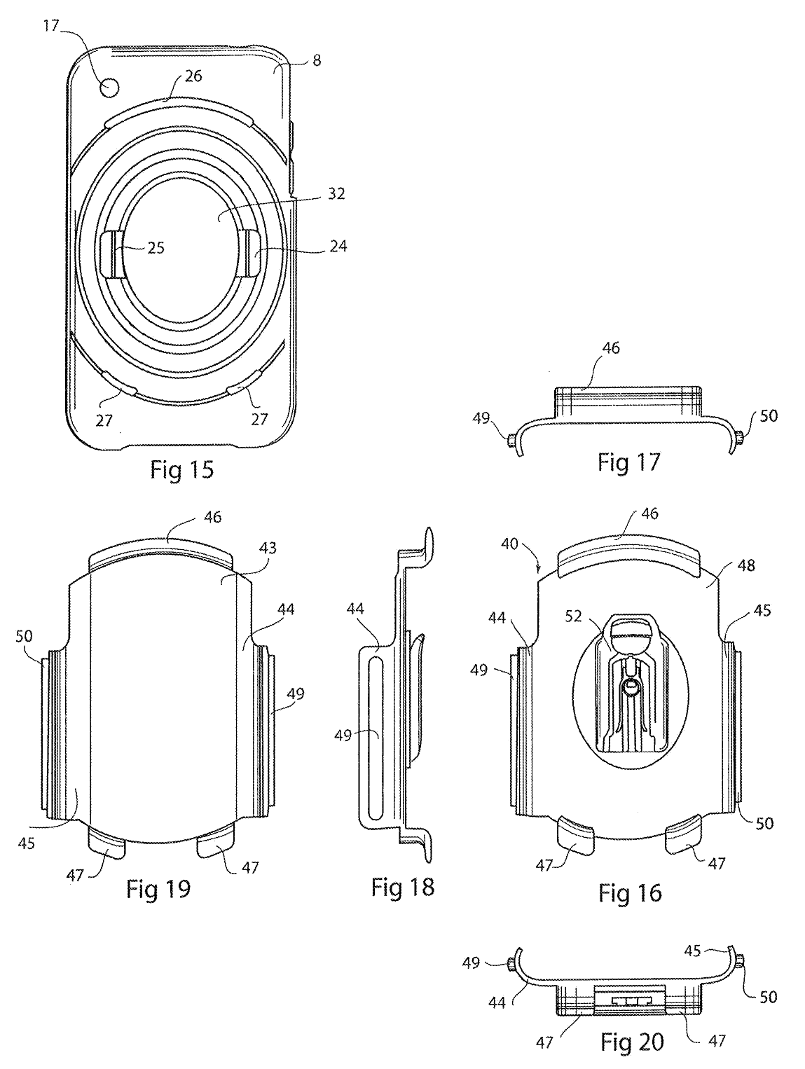

As is seen particularly clearly in FIGS. 10-15, which show the shell 2 alone, the shell has a front surface 3, a right side surface 4, a left side surface 5, a top surface 6, a bottom surface 7 and a rear surface 8. The front surface 3 has a cutout window 11 through which a touch screen of the mobile telephone can be accessed and various other cutouts 12-17 for accessing controls and ports as well as a camera lens of the mobile telephone. The mobile telephone is inserted into the shell 2 through the cutout window 11. Embossed areas 20-23 are also provided for accessing controls, but are not cutouts. The purpose of the other cutouts shown in FIGS. 1-9 is to accommodate the insert 40.

FIGS. 16-20 show that the rear insert 40 includes a front surface 43, lateral clips 44, 45, an L-shaped upper reel segment 46, two L-shaped lower reel segments 47 and a rear surface 48. Elongated vertical projections 49, 50 are formed on the respective lateral clips 44, 45. Finally, a mounting 52 projects from the rear surface 48 for attachment of a device for attaching the case, such as a belt clip, for example those manufactured by the firm Krussel under the designation MULTIDAPT® as is shown in allowed U.S. Design application Ser. No. 29/251,840 and incorporated herein by reference.

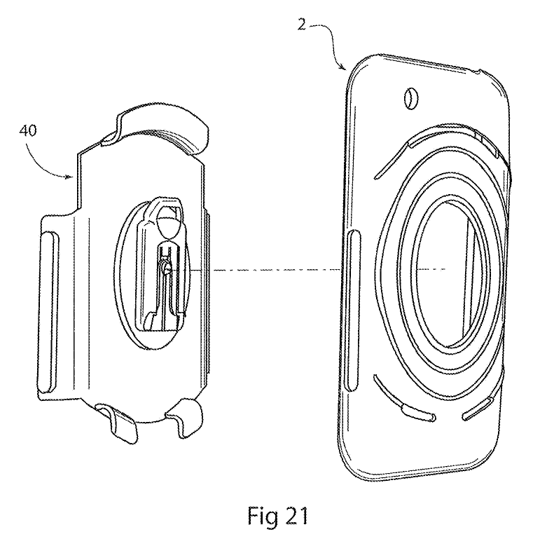

FIG. 21 illustrates how the insert 40 is oriented relative the shell 2 for assembly. After assembly, as shown in FIGS. 1-9, the L-shaped reel segments 46, 47, providing a device for accommodating an ear bud cord, pass through respective openings or slits 26, 27 in the shell 2 and the projections 49, 50 pass through respective cutouts 29, 30 in the shell 2. Finally, the clip 52 passes through a large opening or cutout 32 in the rear surface 8 of the shell 2.

As is seen in FIG. 7, a cord 55 of ear buds 56 is wrapped around the reel segments 46, 47 as well as projections 24 on the rear surface 8 of the shell 2. The projections 24 may have slits 25 formed therein for receiving the cord 55 as well.

1. A mobile telephone case, comprising:
a shell; and
an insert disposed in said shell;
said insert having a reel for receiving a cord to be wound thereon, and said insert having clips for holding a mobile telephone.

2. The case according to claim 1, wherein said shell has front and rear surfaces, said front surface has a cutout for accessing a screen of the mobile telephone, and said rear surface has at least one slot through which said reel extends.

3. The case according to claim 1, wherein said clips are disposed within said shell.

4. The case according to claim 2, wherein said reel includes reel segments extending through multiple slots in said rear surface of shell.

5. The case according to claim 1, wherein said insert has a mounting extending through an opening in a rear surface of said shell for receiving a belt clip.

6. The case according to claim 4, wherein said insert has a mounting extending through a central opening in a rear surface of said shell for receiving a belt clip, said shell has projections with slits formed therein for receiving the cord, said projections are disposed laterally of said central opening and said slots are disposed above and below said central opening.

7. The case according to claim 1, wherein said clips and said reel project from opposite surfaces of said insert.

8. The case according to claim 1, wherein said clips have projections thereon engaged in openings in said shell.

9. The case according to claim 1, wherein said shell has a front surface partially covering the mobile telephone.

10. The case according to claim 1, wherein said shell has at least one of cutouts and embossed areas for accessing at least one of controls, ports and a camera lens of the mobile telephone.

11. The case according to claim 1, wherein said shell is formed of a pliant material to be pulled over the mobile telephone without opening said case, and said insert is formed of a rigid material for supporting a device for attaching the case.
